(19) United States
(12) Patent Application Publication
(10) Pub. No.: US 2023/0091293 A1
(43) Pub. Date: Mar. 23, 2023

(54) CONTINUOUS MONITORING AND/OR PROVISIONING OF SOFTWARE

(71) Applicant: Robert Bosch GmbH, Stuttgart (DE)

(72) Inventor: Paulius Duplys, Markgroeningen (DE)

(21) Appl. No.: 17/939,395

(22) Filed: Sep. 7, 2022

(30) Foreign Application Priority Data
Sep. 17, 2021 (DE) 10 2021 210 327.8

(51) Int. Cl. G06F 21/57

(52) U.S. Cl. CPC G06F 21/577; G06F 2221/033

(57) ABSTRACT

A computer-implemented method for continuously monitoring configurations of software for a system. The method includes providing input data to a plurality of digital twins for the system, wherein the digital twins have different configurations of the software for the system; monitoring at least one digital twin, of the plurality of digital twins, which is executed at least on the basis of the input data, wherein the monitoring is designed to recognize an abnormal state of the at least one digital twin; and evaluating the configuration of the software of the at least one digital twin as ineligible for provisioning if at least one abnormal state was recognized during the monitoring of the at least one digital twin. A computer-implemented method for continuously provisioning software for a system is also provided.

### CROSS REFERENCE

The present application claims the benefit under 35 U.S.C. § 119 of German Patent Application No. DE 10 2021 210 327.8 filed on Sep. 17, 2021, which is expressly incorporated herein by reference in its entirety.

### BACKGROUND INFORMATION

Digital twins can be used to digitally map “real” (tangible and/or intangible) systems or partial aspects thereof to a certain extent. Such mappings may be based on models and/or simulations, in particular when the systems to be mapped are dynamic systems that depend on, for example, temporally variable input data. In such a case, the digital twins may also be considered as dynamic systems that likewise may depend on temporally variable input data. These input data may, for example, be given by or depend on input data of one or more systems to be mapped. Alternatively or additionally, the input data of the digital twins may be generated and/or changed synthetically (e.g., if input data of the real systems may not be used directly for data protection reasons). From the behavior of the digital twins, conclusions (e.g., predictions and/or evaluations) for the real systems can be drawn.

Software may have errors, in particular starting from a certain complexity, e.g., if it comprises a plurality of subunits, such as functions, modules, classes, routines, etc. For example, errors in software may be used to intrude and manipulate software from the outside in an unauthorized manner. If the software is used in a system, e.g., in an embedded system, the functionality of the system generally also depends on the software. Here, for example, the functionality of the system can then also be manipulated by manipulating the software.

Starting from a certain complexity, software is often developed by a multitude of software developers and in responsibilities distributed among the subunits of the software. The subunits of the software, which are respectively developed substantially independently of one another, may then be integrated into the software. For example, the times at which subunits are integrated into the software may already be defined in advance, e.g., in a software development plan. Alternatively or additionally, the respective software developers may integrate subunits of the software into the software at any time (as part of the software development plan) and as needed and/or as progress is made. Such a procedure may be implemented, for example, via a server-based continuous integration system (CI). The plurality of subunits of the software may result in a plurality of different configurations of the software.

Integration of the subunits into the software is usually followed by the provisioning of the software. This may also take place at certain times and/or continuously, i.e., at any time and/or respectively after changing an integration state, via a server-based continuous deployment/delivery system (CD), for example. The (server-based) continuous integration system and the (server-based) continuous deployment/delivery system may be combined in a (server-based) continuous integration and deployment/delivery system (CI/CD).

A disadvantage of such an automated provisioning of the software may be that software is also provisioned in erroneous and/or insecure configurations and may even be already used in systems, e.g., embedded systems. If such erroneous and/or insecure configurations of the software become known, they may (and should) be subsequently corrected, e.g., by a software update.

### SUMMARY

A first general aspect of the present invention relates to a computer-implemented method for continuously monitoring configurations of software for a system. According to an example embodiment of the present invention, the method comprises providing input data to a plurality of digital twins for the system, wherein the digital twins have different configurations of the software for the system. The method furthermore comprises monitoring at least one digital twin, of the plurality of digital twins, which is executed at least on the basis of the input data, wherein the monitoring is designed to recognize an abnormal state of the at least one digital twin. The method furthermore comprises evaluating the configuration of the software of the at least one digital twin as ineligible for provisioning if at least one abnormal state was recognized during the monitoring of the at least one digital twin. The method may comprise adding an entry, comprising the configuration of the software of the at least one digital twin, to a predetermined negative list if the configuration of the software has been evaluated as ineligible for provisioning.

A second general aspect of the present invention relates to a computer-implemented method for continuously provisioning software for a system, in particular error-free and/or safe software (if possible) for the system. According to an example embodiment of the present invention, the method comprises receiving a configuration of the software. The method furthermore comprises checking, at least on the basis of a predetermined negative list, whether the configuration of the software is ineligible for provisioning. The method furthermore comprises non-provisioning of the software in this configuration if the result of the check is positive.

The predetermined negative list in the computer-implemented method for continuously provisioning software for the system according to the second general aspect (or an embodiment thereof) may be generated and/or adjusted by the computer-implemented method for continuously monitoring the configurations of the software for the system according to the first general aspect (or an embodiment thereof).

A third general aspect of the present invention relates to a computer system, in particular to a continuous integration and/or deployment/delivery system designed to perform the computer-implemented method for continuously monitoring configurations of software for a system according to the first general aspect (or an embodiment thereof).

A fourth general aspect of the present invention relates to a (further) computer system, in particular to a continuous integration and/or deployment/delivery system designed to perform the computer-implemented method for continuously provisioning software for a system according to the second general aspect (or an embodiment thereof).

A fifth general aspect of the present invention relates to a computer program designed to perform the computer-implemented method for continuously monitoring configurations of software for a system according to the first general aspect (or an embodiment thereof) and/or the computer-implemented method for continuously provisioning software for a system according to the second general aspect (or an embodiment thereof).

A sixth general aspect of the present invention relates to a computer-readable medium or signal, which stores and/or contains the computer program according to the fifth general aspect.

A seventh general aspect of the present invention relates to a computer system designed to execute the computer program according to the fifth general aspect.

In particular, starting from a certain complexity (e.g., with a plurality of subunits and/or many subversions of the subunits), software may be erroneous and/or insecure despite various efforts. Errors and/or security gaps may be used (exploited) to manipulate the software and often also the associated system (e.g., an embedded system, in particular for controlling, regulating, and/or monitoring a technical system). Often times, the errors and/or security gaps are only discovered retrospectively, i.e., when the software has already been provisioned and possibly has even already been used in one or more systems, for example. In some circumstances, however, impairment and/or damage may have already occurred due to the erroneous/insecure software or of the associated system. If an error or an insecure location is found for software that has already been provisioned and/or used, the software can (and should) be updated and thus repaired at least retrospectively (and generally with some delay). For software and systems that are already used in the vehicle, for example, and in particular in the vehicle field, the update of the software may not be updated [sic] as quickly as possible in some circumstances (e.g., only during the next service or only during the next vehicle stop with the consent of the vehicle user).

The computer-implemented methods provided according to the present invention are aimed at checking the software already prior to provisioning for errors and/or insecurities and recognizing the latter in a timely manner (i.e., prior to provisioning and/or use). At least a portion of errors and/or security gaps in provisioned and/or used software can thereby be avoided. This makes it possible to increase the reliability and/or security of the software and of the associated system. The methods of the present invention provided in this disclosure are particularly advantageous if the software and/or the associated systems are designed restrictively and the functionality of the software/systems is thus clearly and/or unambiguously defined. For example, the functionality of such software/systems is determined or certified according to specifications and/or standards. In contrast to, for example, multi-purpose computers with universal operating systems, embedded systems in particular can be designed restrictively.

According to an example embodiment of the present invention, checking the software (prior to provisioning) may comprise monitoring the at least one digital twin and evaluating the configuration of the software of the at least one digital twin with respect to its (in)eligibility. Alternatively or additionally, checking the software (prior to provisioning) may comprise monitoring each digital twin of the plurality of digital twins and evaluating the respective configuration of the software of each digital twin with respect to the (in)eligibility thereof. The plurality of digital twins, and in particular their number, may correlate with the complexity of the software (e.g., number of subunits, number of subversions of the subunits), and/or be inversely proportional to the restrictivity of the software/system. Thanks to the plurality of digital twins, a plurality of configurations of the software can already be tested realistically even prior to provisioning.

The computer-implemented methods provided according to the present invention may in particular be advantageously used for continuously monitoring and evaluating configurations of the software and/or for continuously provisioning/non-provisioning the software in respective configurations. They can thus, for example, be integrated in a (server-based) continuous integration and/or deployment/delivery system. For example, the continuous monitoring and evaluation of configurations of the software and/or the continuous provisioning/non-provisioning of the software in respective configurations may extend to the planned software development time (or portions thereof) (according to the software development plan).

In comparison to software development with times already defined in advance, e.g., in a software development plan, for the integration and/or provisioning of subunits of the software, continuous integration and/or continuous provisioning may reduce the development time of software. On the other hand, software that is integrated and/or provisioned via common continuous integration and/or deployment/delivery systems may be particularly susceptible to errors and/or security gaps, which are, for example, overlooked as a direct result of the high level of automation of the continuous integration and/or deployment/delivery system and a rather low-threshold check. The methods according to an example embodiment of the present invention may in this respect be seen as an extension of such continuous integration and/or deployment/delivery systems: Thanks to the plurality of digital twins, an in-depth and thorough check of the configurations of the software can be automated and thus integrated into conventional continuous integration and/or deployment/delivery systems. Thus, even complex software, in particular for safety-relevant applications (e.g., in the vehicle), can be developed, integrated, and provisioned quickly and nevertheless in a manner that is as error-free and/or secure as possible. In particular, errors and/or security gaps in the software and the associated systems that are already used (e.g., in the vehicle field) can be largely avoided.

The computer-implemented methods provided according to the present invention may also be offered to third parties via a server, in particular within the framework of a continuous integration and/or deployment/delivery system. Such services can generate annually recurring revenues (ARRs).

### BRIEF DESCRIPTION OF THE DRAWINGS

FIG. 1 schematically illustrates a computer-implemented method for continuously monitoring configurations of software for a system, according to an example embodiment of the present invention.

FIG. 2 schematically illustrates a computer-implemented method for continuously provisioning software for a system, according to an example embodiment of the present invention.

FIG. 3 shows an embodiment of the computer-implemented method for continuously provisioning software for a system, according to an example embodiment of the present invention.

FIG. 4 schematically illustrates a continuous integration and/or deployment/delivery system, according to an example embodiment of the present invention.

### DETAILED DESCRIPTION OF EXAMPLE EMBODIMENTS

The computer-implemented methods 100, 200 provided according to the present invention are aimed at provisioning software for a system quickly and reliably. In particular, they are aimed at already recognizing errors and/or security gaps in the software prior to the provisioning of the software and, in particular, prior to the use of the software and of the associated system (e.g., in the vehicle field). This makes it possible to increase the reliability and/or security of the software and of the associated system.

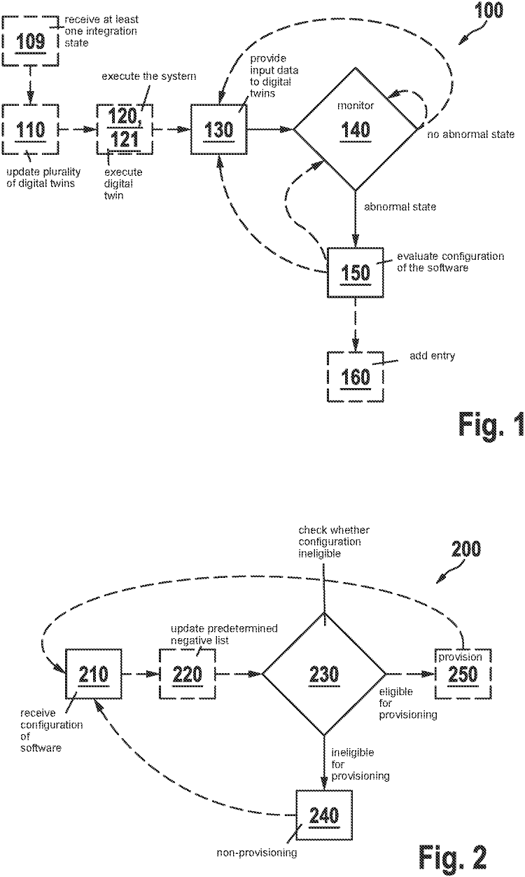

The methods may in particular be advantageously used for continuously monitoring and evaluating configurations of the software and/or for continuously provisioning/non-provisioning the software in respective configurations. For example, the monitoring and evaluation of configurations of the software may be continuous in that the monitoring and evaluation of the configurations of the software may be repeated (as often as desired and/or over a period of time). Alternatively or additionally, the continuous provisioning/non-provisioning of the software in the respective configurations may be continuous, for example, in that the provisioning/non-provisioning of the software in the respective configurations may be repeated (as often as desired and/or over a period of time). For example, the period of time may span the software development time and/or a portion thereof. For example, at least one repetition may take place at predetermined intervals, particularly at regular intervals. Alternatively or additionally, at least one repetition may be triggered, for example, in an event-oriented manner, for example as a result of a new integration state of the software (during software development). Alternatively or additionally, for example, at least one repetition may be requested via a user interface of the continuous integration and/or deployment/delivery system 300, 400. Such repetitions are illustrated schematically in FIGS. 1-3 by dashed return arrows (e.g., in FIG. 1: from 150 to 130 and/or 140, from 140 (no abnormal state) to 130 and/or 140, in FIG. 2: from 240 to 210, from 250 to 210).

The system may be a technical system. For example, the system may be an embedded system. The embedded system may comprise hardware, such as an electronic computer, and (implemented) software, both of which are embedded in a technical context. The embedded system may at least be designed, by means of hardware and/or software, to monitor, control, and/or regulate a further technical system. Alternatively or additionally, the embedded system may be designed to receive data and/or signals. Alternatively or additionally, the embedded system may be designed to process data and/or signals. Alternatively or additionally, the embedded system may be designed to send data and/or signals.

The (further) technical system may, for example, be a mechatronic system. The (further) technical system may, for example, be a vehicle or a technical (sub)system within the vehicle (e.g., an engine controller). Alternatively or additionally, the (further) technical system may be a robot or a technical (sub)system within the robot. Alternatively or additionally, the (further) technical system may be an industrial plant or a technical (sub)system within the industrial plant. Alternatively or additionally, the (further) technical system may be a technical system of networked and/or remotely controllable devices, such as a smart home (e.g., thermal controller).

The system and/or its software may, for example, be designed restrictively. For example, the system and/or its software may be restricted by a specification. This can prevent, for example, the software of the system from being extended by any applications, functionalities, and/or interfaces, and the plurality of digital twins from becoming arbitrarily large.

Disclosed is a computer-implemented method 100 for continuously monitoring configurations of software for a system, according to the present invention. For example, the continuous monitoring of the configurations of the software may be aimed at recognizing errors in the respective configurations of the software. Alternatively or additionally, the continuous monitoring of the configurations of the software may be aimed at recognizing security gaps that may be exploited for an attack, for example. The method 100 may, for example, be implemented in a continuous integration and/or deployment/delivery system 300, 400 (e.g., via a server). The monitoring of the configurations of the software may, for example, be continuous in that it may extend over the software development time of the software or a portion thereof.

The method 100 comprises providing 130 input data to a plurality of digital twins for the system, wherein the digital twins have different configurations of the software for the system. Providing 130 of the input data may likewise be continuous.

The software may be structured in a (certain) complexity. For example, it may have a plurality of subunits, e.g., >=1, >=2, >=5, >=10, >=20, >=50, >=100, >=1e4 subunits. A subunit may be, for example, an operating system (core). Alternatively or additionally, a subunit may, for example, be a library. Alternatively or additionally, a subunit may be a runtime component. Alternatively or additionally, a subunit may be an application. Alternatively or additionally, a subunit may be a function. Alternatively or additionally, a subunit may be a module. Alternatively or additionally, a subunit may be a class. Alternatively or additionally, a subunit may be a routine. The complexity of the software may be the greater, the more subunits it comprises. Subunits are often developed by and/or the responsibility of different software developers. In any case, any development level of a subunit of the software may be uniquely identified by a (sub)version. The software may thus be present in a plurality of different configurations, wherein two configurations of the software may be different if the (sub)versions of at least one subunit of the software differ in the two configurations of the software. The software of a digital twin and the software of another digital twin may thus have different configurations if the software of the one digital twin and the software of the other digital twin differ in the (sub)version of at least one subunit.

For example, the plurality of digital twins for the system may comprise >=1, >=2, >=5, >=10, >=20, >=50, >=100, >=1e4 digital twins. The number of digital twins may be correlated with the number of different configurations of the software. However, there may also still be several digital twins for a configuration of the software in order to test various input data (e.g., as in the Monte Carlo method), for example.

The method 100 furthermore comprises monitoring 140 at least one digital twin, of the plurality of digital twins, which is executed at least on the basis of the input data. When executing the at least one digital twin, its configuration of the software may in particular be executed. The monitoring 140 is designed to recognize an abnormal state of the at least one digital twin, i.e., during execution/operation thereof. The monitoring 140 may comprise an abnormality recognition algorithm. For example, the abnormality recognition algorithm may be a classification algorithm. The classification algorithm may in particular comprise a (trained) machine learning algorithm, such as an artificial neural network or a support vector machine.

The method 100 may also comprise monitoring each digital twin of the plurality of digital twins, wherein each digital twin is executed at least on the basis of the input data. In this case, the monitoring may be designed to recognize abnormal states of the digital twins during execution/operation thereof.

The method 100 furthermore comprises evaluating 150 the configuration of the software of the at least one digital twin as ineligible for provisioning (e.g., in the continuous integration and/or deployment/delivery system 300, 400) if at least one abnormal state was recognized during the monitoring 140 of the at least one digital twin. The method 100 is schematically illustrated in FIG. 1.

The method 100 may furthermore comprise: adding 160 an entry, comprising the configuration of the software of the at least one digital twin, to a predetermined negative list NL if the configuration of the software has been evaluated 150 as ineligible for provisioning. In other words: By adding 160 the entry, the ineligibility of the configuration of the software of the at least one digital twin is captured and stored in the predetermined negative list NL. The method 100 may likewise comprise: not adding an entry, comprising the configuration of the software of the at least one digital twin, to the predetermined negative list NL if the configuration of the software has been evaluated as eligible for provisioning. The predetermined negative list NL may thus be a list listing configurations of the software evaluated 150 as ineligible.

The predetermined negative list NL may initially comprise an empty set (e.g., at the start of software development). In this case, an entry is then not yet contained in the predetermined negative list. Alternatively, the predetermined negative list may be preconfigured with at least one entry (e.g., for a configuration of the software that is designed for testing purposes only). In both cases, for example in the course of software development, the predetermined negative list can be extended, for example by means of the method 100, by entries corresponding to configurations of the software that were, for example, respectively evaluated 150 as ineligible.

Alternatively or additionally, the method 100 may comprise adjusting the predetermined negative list NL. For example, adjusting may comprise deleting an entry of the predetermined negative list NL if the configuration of the software associated with the entry of the predetermined negative list NL has been incorrectly evaluated 150 as ineligible for provisioning. By adding 160 the entry to the predetermined negative list NL or, more generally, by adjusting the predetermined negative list NL, a predetermined negative list NL is again generated.

An entry of the predetermined negative list NL may uniquely identify at least one configuration of the software (ineligible for provisioning). Alternatively or additionally, an entry of the predetermined negative list NL may uniquely identify a plurality of configurations (ineligible for provisioning). Such an entry may, for example, comprise a logical expression (e.g., a regular expression). For example, an entry may comprise an inequality regarding (sub)versions of a subunit of the software, for example: “(sub)version of submodule A < 1.3.2 & (sub)version of submodule B < 5.3.1.”

Furthermore, an entry of the predetermined negative list NL may comprise metadata. For example, during adding 160, additional information for reporting and/or logging (e.g., time of evaluating 150, boundary conditions, ...) that may be received via a user interface of the integration and/or deployment/delivery system can be written into the entry.

The method 100 may comprise executing 120 the system. In the case of a plurality of similar systems, the method 100 may alternatively or additionally comprise executing each system or a portion of the plurality of similar systems. For example, systems may be similar if their software matches or the systems differ only in the configurations of the software. On the other hand, executing 120 the system and/or systems of the plurality of similar systems need not be part of the method. For example, the system and/or systems of the plurality of similar systems may be executed/operated independently of the method 100.

Alternatively or additionally, the method 100 may comprise executing 121 the at least one digital twin. Alternatively or additionally, the method 100 may comprise executing each digital twin or a portion of the plurality of digital twins.

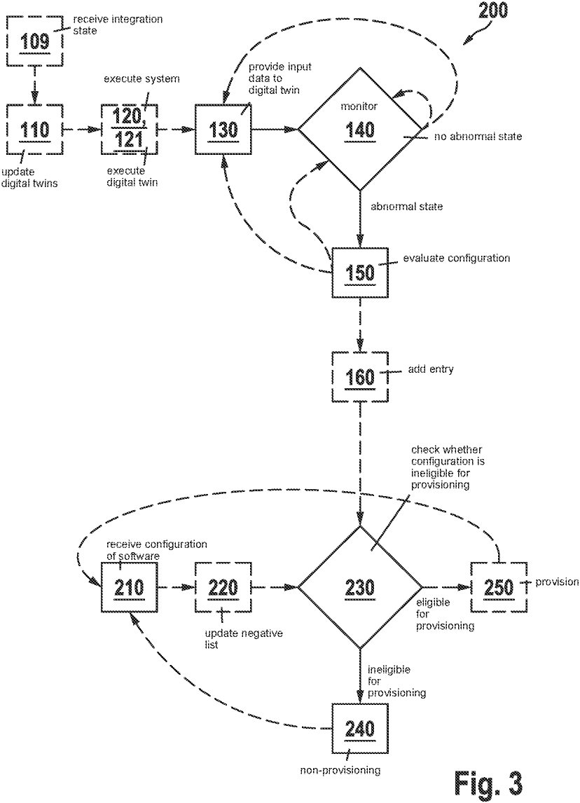

For example, executing 120 the system (or systems) and/or executing 121 the at least one digital twin (or plurality of digital twins) may precede providing 130 the input data to the plurality of digital twins, as shown in FIG. 1 and FIG. 3. For example, data may thereby be recorded during the execution/operation of the system and likewise provided to the at least one digital twin during the execution/operation of the at least one digital twin. In the case of fast data transfer, monitoring 140 the at least one digital twin (or the plurality of digital twins) may comprise quasi-real-time analyses.

The provided 130 input data may comprise input data of the system (or systems) and/or data derived therefrom. For example, input data of the system (or systems) may comprise network traffic and/or payload data. For example, the system (or systems) may be executed during the method 100 or prior to the method 100.

The provided 130 input data may depend on at least one random variable. In other words, the provided 130 input data may comprise random numbers according to a probability distribution. For example, input data that cannot be fully determined may be replaced by random numbers. Alternatively or additionally, the provided 130 input data may be based on fuzzing. Fuzzing is an automated technique for software testing in which random numbers are provided as input data in order to test the robustness of the software against unexpected input, for example.

The at least one abnormal state of the at least one digital twin may comprise an error during execution of the at least one digital twin. Errors may, for example, respectively be encoded by an error value. An error may, for example, be overwriting data stored in selected files/memory areas. Alternatively or additionally, an error may, for example, be a corrupt memory area. Alternatively or additionally, an error may, for example, be a runtime error (e.g., division by zero). Alternatively or additionally, an error may, for example, be a crash.

Alternatively or additionally, the at least one abnormal state of the at least one digital twin may comprise a deviation from states of the remaining digital twins of the plurality of digital twins, wherein the remaining digital twins are likewise executed on the basis of the provided 130 input data. Alternatively or additionally, the at least one abnormal state of the at least one digital twin may comprise intrusion as a result of an intrusion detection system in the at least one digital twin.

The method 100 may comprise updating 110 the plurality of digital twins for the system. For example, during updating 110, the plurality of digital twins may be extended by generating at least one new digital twin. Alternatively or additionally, during updating 110, the plurality of digital twins may, for example, be reduced by deconstructing or deactivating at least one existing digital twin. Alternatively or additionally, during updating, the plurality of digital twins may, for example, be changed by adjusting at least one existing digital twin. Updating 110 may be based on at least one integration state of the software. Updating 110 may also be based on each integration state of the software. By depending on integration states, it can be ensured that the plurality of digital twins of the system and thus the monitoring 140 of the at least one digital twin (or each digital twin) of the plurality of digital twins corresponds to a current software development level. For example, as shown in FIG. 1 or FIG. 3, updating 110 may take place prior to steps 120, 121, and 130. Otherwise, after updating 110, steps 120, 121, and 130 may be repeated.

Updating 110 the plurality of digital twins for the system can be triggered according to a predetermined criterion. The predetermined criterion may implement an update policy/configuration (p). For example, it may thereby be taken into account if new (sub)versions of the software and/or its subunits are issued/integrated or if certain subunits of the software and/or their (sub)versions are no longer supported. For example, the predetermined criterion may be designed to generate, when a new (sub)version for a subunit of the software (e.g., a more complex library) is issued/integrated, a further plurality of digital twins by which the plurality of digital twins is extended. The further plurality of digital twins can then be (pre)configured with different input data and/or random numbers. In other words, the update 110 may be automated by means of the predetermined criterion. Such automation may be advantageous for a continuous integration and/or deployment/delivery system 300. Alternatively or additionally, the update 110 may be manually triggered via a user interface.

The method 100 may comprise receiving 109 at least one integration state for the software. Receiving 109 may take place, for example, by retrieving the at least one integration state or may be triggered by the integration and/or deployment/delivery system, for example after an integration step has been completed. The method 100 may also comprise receiving each integration state for the software. For example, receiving 109 the at least one integration state for the software may precede the update 110 of the plurality of digital twins for the system, as shown in FIG. 1 or FIG. 3.

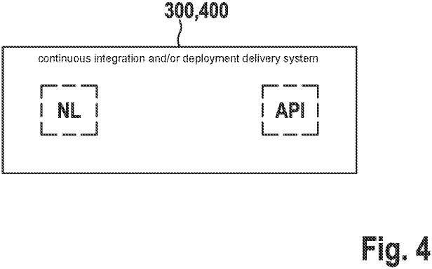

The (predetermined) negative list NL and/or portions (e.g., individual entries of the predetermined negative list NL) thereof may be retrievable via an application interface API (also: programming interface, application programming interface), and in particular continuously retrievable, i.e., at various times of a certain period of time. The application interface API is schematically shown in FIG. 4. Alternatively or additionally, the (predetermined) negative list NL and/or portions thereof may be retrievable via a user interface, for example of the continuous integration and/or deployment/delivery system. Such interfaces may, for example, be used by software developers of the software during development. Furthermore, a third party (e.g., supplier, software tester, certifier, ...) may also be permitted to use such interfaces, in particular if it is certain that the ineligible configurations of the software listed as entries in the predetermined negative list NL are not used in systems.

Furthermore disclosed is a computer-implemented method 200 of the present invention for continuously provisioning software for a system, in particular error-free and/or secure software (if possible) for the system. The method 200 may be implemented in an integration and/or deployment/delivery system. The method 200 is aimed at provisioning, and thus being able to use in the system, only configurations of the software eligible for provisioning. This makes it possible to increase the reliability and/or security of the system and the software thereof. The method is schematically shown in FIG. 2.

The method 200 comprises receiving 210 a configuration of the software. It may prove advantageous to receive, according to the method 200, any configuration of the software that is to be provisioned, and to check it for (in)eligibility for provisioning.

The method furthermore comprises checking 230, at least on the basis of a predetermined negative list NL, whether the configuration of the software is ineligible for provisioning. The negative list NL may be predetermined if it is available at a time immediately prior to checking 230.

The method furthermore comprises non-provisioning 240 of the software in this configuration if the result of the check 230 is positive, i.e., if the configuration of the software has been evaluated during the check 230 as ineligible for provisioning.

The method 200 may permit provisioning 250 the software in this configuration if the result of the check 230 is negative, i.e., if the configuration of the software has been evaluated during the check 230 as non-ineligible and thus as eligible for provisioning.

One or more entries (if present) in the predetermined negative list NL may each correspond to at least one configuration of the software which is ineligible for the provisioning of the software.

Checking 230 whether the configuration of the software is ineligible for provisioning may comprise checking whether the configuration of the software corresponds to at least one entry of the predetermined negative list NL. For example, the configuration of the software may correspond to an entry of the predetermined negative list NL if it is equal to the entry. Alternatively or additionally, the configuration of the software may correspond to an entry of the predetermined negative list NL if the entry comprises a predetermined criterion (e.g., a regular expression) satisfied by the configuration of the software, e.g., “(sub)version of module A <= 5.3.1.”

The method 200 may comprise updating 220 the predetermined negative list NL, wherein a predetermined negative list NL again results. Updating 220 may precede checking 230, as shown in FIG. 2. The sequence of steps 210 and 220 may be irrelevant. For example, updating 220 may comprise reading the predetermined negative list NL or an incremental update to the predetermined negative list NL from a server. Updating 220 the predetermined negative list NL implies that the negative list is current. This makes it possible to increase the reliability and/or security of the provisioned software.

The predetermined negative list NL in method 200 may be generated and/or adjusted by the computer-implemented method 100 for continuously monitoring the configurations of the software for the system. Such a combination of the two methods 100, 200 is shown schematically in FIG. 3. Based on this combination, it may be advantageous to implement both methods 100, 200 in an integration and/or deployment/delivery system.

Furthermore disclosed is a continuous integration and/or deployment/delivery system 300 of the present invention designed to perform the computer-implemented method 100 for continuously monitoring the configurations of the software for the system. The continuous integration and/or deployment/delivery system 300, shown schematically in FIG. 4, may comprise a server.

Furthermore disclosed is a continuous integration and/or deployment/delivery system 400 of the present invention designed to perform the computer-implemented method 200 for continuously provisioning the software for the system. The continuous integration and/or deployment/delivery system 400, shown schematically in FIG. 4, may likewise comprise a server. The continuous integration and/or deployment/delivery system 400 may (but need not) correspond to the continuous integration and/or deployment/delivery system 300.

Furthermore disclosed is a computer program of the present invention designed to perform the computer-implemented method 100 for continuously monitoring the configurations of the software for the system. Alternatively or additionally, the computer program (or a further computer program) may be designed to perform the computer-implemented method 200 for continuously provisioning the software for the system. The computer program (and/or the further computer program) may, for example, be present in interpretable or in compiled form. For execution, it may be loaded (also in portions) into the RAM of a control unit or computer as a bit or byte sequence, for example, wherein a computer may also function as a server.

Furthermore disclosed is a computer-readable medium or signal storing and/or containing the computer program (and/or the further computer program), according to the present invention. The medium may, for example, comprise one of RAM, ROM, EPROM, HDD, SDD, ... on/in which the signal is stored.

Furthermore disclosed is a computer system according to the present invention designed to execute the computer program (and/or the further computer program). The computer system may be the continuous integration and/or deployment/delivery system 300, 400. In particular, the computer system may comprise at least one processor and at least one working memory (e.g., RAM, ...). Furthermore, the computer system may comprise a memory (e.g., HDD, SDD, ...). The computer system comprise a server on a network (e.g., the internet, ...).

What is claimed is:

1. A computer-implemented method for continuously monitoring configurations of software for a system, the method comprising the following steps:
providing input data to a plurality of digital twins for the system, wherein the digital twins have different configurations of the software for the system;
monitoring at least one digital twin, of the plurality of digital twins, which is executed at least based on the input data, wherein the monitoring is configured to recognize an abnormal state of the at least one digital twin;
evaluating the configuration of the software of the at least one digital twin as ineligible for provisioning when at least one abnormal state was recognized during the monitoring of the at least one digital twin.

2. The method as recited in claim 1, further comprising:
adding an entry, including the configuration of the software of the at least one digital twin, to a predetermined negative list, based on the configuration of the software being evaluated as ineligible for provisioning.

3. The method as recited in claim 1, wherein the provided input data includes input data of the system and/or data derived from the input data of the system.

4. The method as recited in claim 1, wherein the provided input data depend on at least one random variable and/or are based on fuzzing.

5. The method as recited in claim 1, wherein the at least one abnormal state of the at least one digital twin includes:
an error in an execution of the at least one digital twin; and/or
a deviation from states of the remaining digital twins of the plurality of digital twins; and/or
an intrusion as a result of an intrusion detection system in the at least one digital twin.

6. The method as recited in claim 1, further comprising:
updating the plurality of digital twins for the system, wherein, during the updating, the plurality of digital twins are: (i) extended by generating at least one new digital twin, and/or (ii) reduced by deconstructing or deactivating at least one existing digital twin and/or (iii) changed by adjusting at least one existing digital twin.

7. The method as recited in claim 6, wherein the updating is based on at least one integration state of the software.

8. The method as recited in claim 6, wherein the updating of the plurality of digital twins for the system is triggered according to a predetermined criterion.

9. The method as recited in claim 1, further comprising:
receiving at least one integration state for the software.

10. The method as recited in claim 1, wherein the predetermined negative list and/or portions of the predetermined negative list are retrievable via an application interface (API).

11. A computer-implemented method for continuously provisioning software for a system, comprising:
receiving a configuration of the software;
checking at least based on a predetermined negative list, whether the configuration of the software is ineligible for provisioning;
non-provisioning the software in the configuration based on a result of the check being positive.

12. The method as recited in claim 11, wherein one or more entries in the predetermined negative list each correspond to at least one configuration of the software which is ineligible for the provisioning of the software.

13. The method as recited in claim 11, further comprising:
updating the predetermined negative list,
wherein the predetermined negative list again results.

14. The method as recited in claim 11, wherein the checking of whether the configuration of the software is ineligible for provisioning comprises checking whether the configuration of the software corresponds to at least one entry of the predetermined negative list.

15. The method as recited in claim 11, further comprising:
provisioning the software in the configuration based on the result of the check being negative.

16. The method as recited in claim 11, wherein the predetermined negative list is adjusted by:
providing input data to a plurality of digital twins for the system, wherein the digital twins have different configurations of the software for the system;
monitoring at least one digital twin, of the plurality of digital twins, which is executed at least based on the input data, wherein the monitoring is configured to recognize an abnormal state of the at least one digital twin;
evaluating the configuration of the software of the at least one digital twin as ineligible for provisioning when at least one abnormal state was recognized during the monitoring of the at least one digital twin.
adding an entry, including the configuration of the software of the at least one digital twin, to the predetermined negative list, based on the configuration of the software being evaluated as ineligible for provisioning.

17. A continuous integration and/or deployment/delivery system configured to continuously monitor configurations of software for a system, the continuous integration and/or deployment/delivery system configured to:
provide input data to a plurality of digital twins for the system, wherein the digital twins have different configurations of the software for the system;
monitor at least one digital twin, of the plurality of digital twins, which is executed at least based on the input data, wherein the monitoring is configured to recognize an abnormal state of the at least one digital twin;
evaluate the configuration of the software of the at least one digital twin as ineligible for provisioning when at least one abnormal state was recognized during the monitoring of the at least one digital twin.

18. A continuous integration and/or deployment/delivery system configured to continuously provision software for a system, the continuous integration and/or deployment/delivery system configured to:
receive a configuration of the software;
check at least based on a predetermined negative list, whether the configuration of the software is ineligible for provisioning;
non-provision the software in the configuration based on a result of the check being positive.
